(19) United States
(12) Patent Application Publication
(10) Pub. No.: US 2012/0146589 A1
(43) Pub. Date: Jun. 14, 2012

(54) Method and Device For Charging Lithium-Cobalt Cells

(76) Inventors: Thomas Wick, Beinwil (CH); Remo Estermann, Root (CH)

(21) Appl. No.: 13/379,920

(22) PCT Filed: Jun. 24, 2009
(86) PCT No.: PCT/CH09/00218

§ 371 Date: Feb. 27, 2012

(51) Int. Cl. H02J 7/04

(52) U.S. Cl. 320/139

(57) ABSTRACT

In order to charge a rechargeable lithium-cobalt cell having a capacity C, the charging current undergoes several cycles (Z1, Z2) and each cycle (Z1, Z2) comprises high-current and low-current phases of different length. During a low-current phase, the current value is I1=C*0.090 (wherein I1 is in amperes and C is in ampere hours), and during a high-current phase, the current value is I2=C*0.165. It has been shown that the cell can thereby be charged at higher energy density and aging effects can thereby be reduced.

### FIELD OF THE INVENTION

The invention is related to the charging of rechargeable batteries, specifically lithium-cobalt cells.

### BACKGROUND

Lithium-cobalt cells have in practice various advantages, i.e. an advantageous ratio between storable energy and weight.

Normally, the cells are charged with an initially constant charging current. When the cells reach a voltage of i.e. each 4.2 V, this voltage is kept until the charging current has dropped to i.e. 3% of the initial current.

In order to make the charging process more efficient there are however also methods known, in case of which the cells are charged with pulsed current, i.e. from US 2009/0066295 or US 2007/0273334.

Nevertheless, it appears that, by means of conventional methods, the charge capacity of charged cells decreases with the time, meaning that the cells are subject to a certain aging. The capacity of the cells decreases.

### DISCLOSURE OF THE INVENTION

Therefore it is a task to provide a method or a device respectively for charging such cells, by means of which or which respectively the cells can be charged to a high energy density which is as much as possible constant.

This task is solved by the method and the device according to the independent claims.

According to this, the cells are charged at least during a time period of the charge process with a charge current which is varied between a first current value I1 and a second current value I2. Thereby, the following conditions apply for the ratio between the current value I1 or I2 respectively and the capacity C of the cell:
I1/C=0.090 h⁻¹ and
I2/C=0.165 h⁻¹,
with I1, I2 in the measurement unit A (Ampere) and C in the measurement unit Ah (ampere hours).

It appears that a charge to high capacities is possible with such a pulse ratio and the cells feature only a small aging. The formation of quotients of current and cell capacity takes into account that (by neglecting the boundary effects) the processes during the charging process depend primarily on the current density in the cell.

The method is particularly advantageous for cells which have a capacity being between 160 and 240 Ah, particularly 200 Ah. Such cells are meanwhile used in very high number particularly for motor vehicles, and in this case the current value I2=C*0.165 h⁻¹ additionally lies between 26.4 and 39.6 A, particularly 33 A, these being currents which can still be generated at public current power supply networks with a relatively small effort with conventional charging stations working at around 230 Volt.

### SHORT DESCRIPTION OF THE DRAWINGS

Further embodiments, advantages and applications of the invention result from the dependent claims and from the now following description by means of the figures. Thereby it is shown in:

FIG. 1 an embodiment of a charging circuit for a battery of cells,

FIG. 2 the cell voltage depending on the time for charging with a constant current,

FIG. 3 the charging current depending on the time for an embodiment of the method according to the invention,

FIG. 4 the cell voltage depending on the time during the charging with the current according to FIG. 3 and

FIG. 5 a section of the diagram of FIG. 3 during a cycle.

### WAYS OF CARRYING OUT THE INVENTION

Definitions:

The term lithium-cobalt cell is here understood as a chargeable accumulator cell which uses LiCoO₂ as active cathode material.

The currents specified in the description and the claims, the values I1/C and I2/C scaled with the cell capacity as well as indicated times are understood with a precision of +/−15% if nothing else is stated. For example, the currents of 18 A and 33 A may vary with +/−2.7 A or +/−4.95 A respectively, without departing from the spirit of the invention.

Charging Circuit:

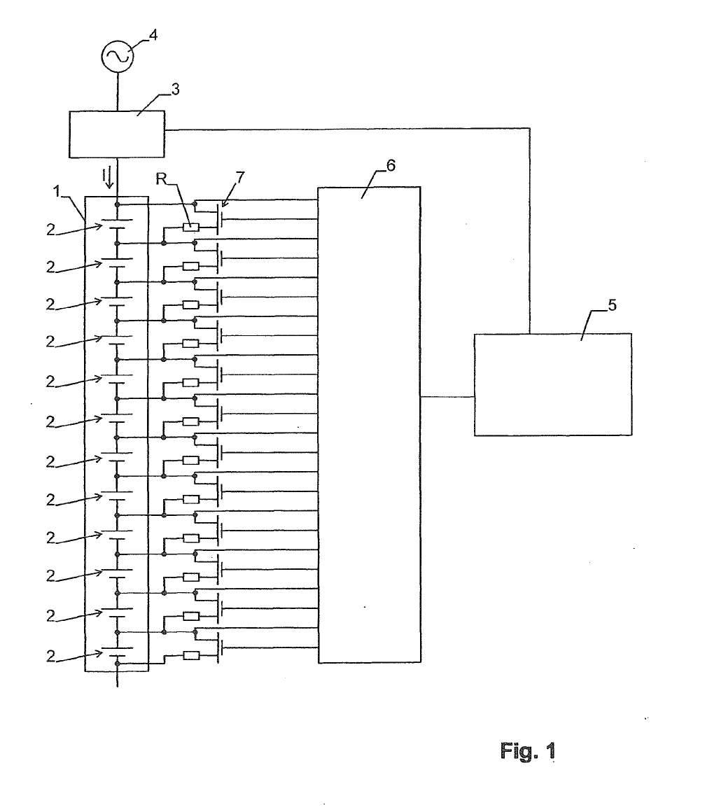

FIG. 1 shows a circuit for charging a battery 1 comprising a series circuit of a plurality of lithium-cobalt cells 2.

A charging device 3 is energized from a current network 4 and generates a charging current I. The charging current I is controlled by a controller unit 5. The controller unit 5 is connected to a battery monitoring component 6. This can be a “Multicell Adressable Battery Stack” LTC6802 of the company Linear Technology Corporation, Milpitas (USA).

The battery monitoring component 6 is itself connected to all cells 2. The controller unit 5 can measure the voltage across each cell via the battery monitoring component 6. Furthermore, it can optionally switch a resistor R parallel to each cell via transistors 7.

The circuit according to FIG. 1 may be cascaded by connecting the controller unit 5 with a plurality of battery monitoring components 6 which each has twelve cells of a larger battery of i.e. altogether 38 batteries connected in series.

The course of the charging process is controlled by the controller unit 5 which is formed and structured accordingly. For example, the controller unit 5 may be formed as a microprocessor which is programmed such that it monitors the voltages across the cells and controls the charging process. Particularly, within the scope of this invention, the controller unit 5 also controls the charging current I and its time-based course. Furthermore, it can control the transistors 7 in order to assure a balancing (meaning an even distribution of the charge) of the individual cells 2 during the charging.

Charging Method:

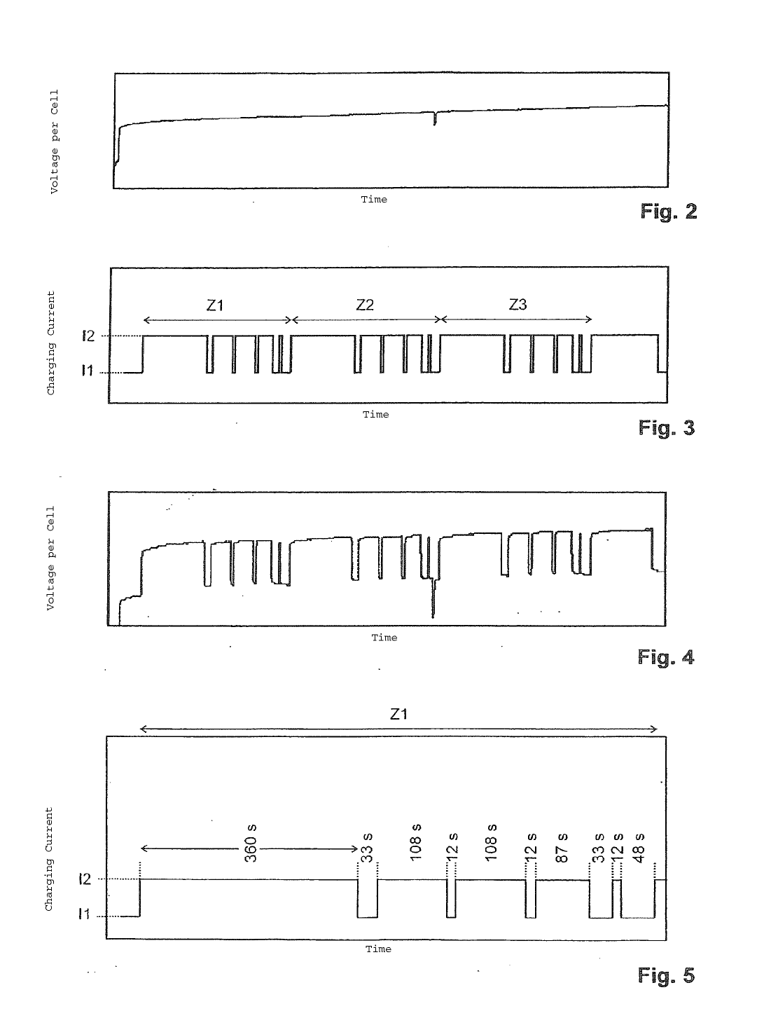

In FIGS. 2 and 4 the average cell voltage is shown for a conventional charging method according to the invention. The data was recorded with a battery which consisted of altogether 38 lithium-cobalt cells connected in series, of which each had a nominal (=factory specification) capacity C=200 Ah. Thereby, these were cells TS LCP 200 by the company Thunder Sky Industrial, Shenzhen, P.R.C. (China).

Experiment 1:

First, in FIG. 2 a charging method not according to the invention is shown, in case of which all cells are charged by means of a constant current, this starting from an average discharge voltage of 114.7V/38=3.02 V per cell, wherein the charging process was stopped when a voltage of 158.8/38=4.18 V was reached. After repeated charging or discharging respectively of the battery a charging and a discharging with the following parameters was reached in this way after 50 charging cycles:

charging: 186 Ah, charged energy 24.2 kWh

discharging: 171 Ah, obtained energy 22.0 kWh

(new cells 195 Ah charged, charged energy 27.4 kWh discharging 184 Ah, obtained energy 25.8 kWh)

The discharging process was carried out by means of a continuous operation of the cells in a motor vehicle on a test track with an average current of 72 A until a discharge of the cells to the above mentioned discharge voltage.

Experiment 2:

FIG. 3-5 illustrate a preferred embodiment of a method according to the invention. In case of the method, the charge current is not constant but it varies by going through a plurality of low-current and high-current phases following each other with current values I1 and I2. The current values I1 and I2 preferably amount to 18 A or 33 A respectively, as mentioned at the beginning. However, because the cells of the embodiment according to FIG. 3-5 had a nominal capacity C=200 Ah, this yields for the normalized values
I1/C=0.090 h⁻¹ and
I2/C=0.165 h⁻¹.

If cells with a capacity C of 160 Ah or 240 Ah respectively are used, the two current values I1 and I2 should have approximately the following values:
C=160 Ah: I1=14.4 A, I2=26.4 A
C=240 Ah: I1=21.6 A, I2=39.6 A

As can be seen from FIG. 3, a plurality of low-current phases of different lengths is provided, likewise a plurality of high-current phases of different lengths.

The length of the phases has to be adjusted to the typical relaxation times of the cells. Preferably, at least some, particularly all, of the low-current phases have lengths of at least 8 seconds and/or lengths of at most 180 seconds, particularly at most 48 seconds. Likewise, at least some, preferably all, of the high-current phases should have lengths of at least 8 seconds and/or lengths of at most 600 seconds, particularly lengths of at most 360 seconds.

These time intervals correspond approximately to the time required until the voltage across the cell is again constant after a strong pulsed current of i.e. 3 seconds and 18 A (in millivolt range).

Suitable lengths for the low-current phases are i.e. 12, 33 and 48 seconds, wherein preferably all of these lengths are used. Suitable lengths for the high-current phases are i.e. 12, 87, 108 and 360 seconds, wherein again all these lengths are preferably used.

As can further be seen from FIG. 3, the charge current goes through a plurality of identical current cycles Z1, Z2, Z3, etc. Each current cycle comprises a plurality of high-current and low-current phases, wherein during a current cycle a plurality of high-current phases of different lengths and/or a plurality of low-current phases of different lengths are provided.

In the embodiment according to FIG. 3, each cycle contains the following sequence: a high-current phase of 360 seconds, a low-current phase of 33 seconds, a high-current phase of 108 seconds, a low-current phase of 12 seconds, particularly further followed by a high-current phase of 108 seconds, a low-current phase of 12 seconds, a high-current phase of 87 seconds, a low-current phase of 33 seconds, a high-current phase of 12 seconds and a low-current phase of 48 seconds. This is related to the reaction times or the reaching of actual states respectively (before the high-current phase). Presently it is suspected that the sequence of pulses of different lengths causes an avoidance of inhomogeneities on the electrodes.

FIG. 4 shows the average cell voltage during the charging of a simple series circuit of 38 cells of which, as mentioned, each has a capacity of C=200 Ah. The horizontal axes of FIGS. 3 and 4 are scaled in the same way, such that the voltage pulses across the cells could be compared to the corresponding current pulses.

The charging should be latest started when the cell voltage drops below a value of 3.02 V, because a strong discharge can affect the functionality of the cells. (Deep discharges may lead to a complete destruction of the accumulator)

In the embodiment according to FIGS. 3 and 4 the charging starts first with a low current, this being however only due to device reasons and not being mandatory in connection with the present invention.

After that, the cycle Z1 starts, followed by the cycle Z2, etc. As can be seen, thereby the average cell voltage increases as presumed. The charging is stopped when a cell voltage of 4.18 V is reached. A charging to higher voltages is not advisable due to security reasons.

In case of a recurring charging or discharging of the battery of this type between 3.02 V and 4.18 V a charging with the following parameters was reached after 70 to 80 charging cycles:

charging: 208 Ah, charged energy 31.9 kWh

discharging: 204 Ah, obtained energy 30.2 kWh

Experiment 3:

The cells were charged under the same conditions as in experiment 2, wherein the charge current consisted of a sequence comprising alternating high-current phases of 33 A during 15 seconds and low-current phases of 18 A during 8 seconds. Results, after 60-65 cycles:

charging: 202 Ah, charged energy 30.1 kWh

discharging: obtained energy 28.1 kWh

Experiment 4:

The cells were charged under the same conditions as in experiment 2, wherein the charge current consisted of a sequence comprising alternating high-current phases of 33 A during 90 seconds and low-current phases of 18 A during 30 seconds. Results, after 55-60 cycles:

charging: 198 Ah, charged energy 28.6 kWh

discharging: obtained energy 26.4 kWh

Experiment 5:

The cells were charged under the same conditions as in experiment 2, wherein the charge current consisted of a sequence comprising alternating high-current phases of 33 A during 300 seconds and low-current phases of 18 A during 180 seconds. Results, after 50-55 cycles:

charging: 191 Ah, charged energy 26.4 kWh

discharging: obtained energy 24.0 kWh

Annotations:

By the course of the charge current according to the invention a “burn-in” (meaning a bad imprinting of the electrolyte and graphite) by constant current during hours or by precisely repeated periodical simple current course patterns can be avoided.

Additionally, an extensive decrease of different zones of conductivity inside a cell can be reached (intercalation), as well as also the increase of the internal resistance promoted by the aging process (Redox process) can be delayed (Oxidation—cake layer formation is tied to irreversible lithium and electrolyte losses.) In first place, the interruption (modulating) of lo the charge current has the highest positive impact. The return to the “idle phase” ( 12/33 sec.) makes possible a good ratio between the performance increase, sustainability and efficiency factor.

Although preferred embodiments of the invention are described in this application, it is clearly pointed out that the invention is not restricted to these and may also be executed in another way within the scope of the now following claims.

1. Method for charging an arrangement of lithium-cobalt cells with a pulsed charge current, characterized in that each cell has a capacity C and in that the charge current of the cell is varied at least during a time period of the charge process between a first current value I1 and a second current value I2, wherein
I1/C=0.090 h⁻¹ and
I2/C=0.165 h⁻¹,
with I1, I2 in the measurement unit A and C in the measurement unit Ah.

2. Method according to claim 1, wherein the capacity C per cell is between 160 and 240 Ah, particularly 200 Ah.

3. Method according to claim 1, wherein the charge current passes through a plurality of low-current and high-current phases, which follow each other, with the current values I1 and I2.

4. Method according to claim 3, wherein a plurality of low-current phases of different lengths is provided and/or a plurality of high-current phases of different lengths is provided.

5. Method according to claim 3, wherein at least a part, particularly all, of the low-current phases have a length of at least 8 seconds and/or a length of at most 180 seconds, particularly at most 48 seconds.

6. Method according to claim 3, wherein at least a part, particularly all, of the high-current phases have a length of at least 8 seconds and/or a length of at most 600 seconds, particularly a length of at most 360 seconds.

7. Method according to claim 3, wherein at least a low-current phase has a length of 12, 33 or 48 seconds, and particularly wherein at least low-current phases with the lengths 12, 33 and 48 seconds are used.

8. Method according to claim 3, wherein at least a high-current phase has a length of 12, 87, 108 or 360 seconds, and particularly wherein at least high-current phases with the lengths 12, 87, 108 and 360 seconds are used.

9. Method according to claim 1, wherein identical current cycles follow each other, wherein each current cycle has a plurality of high-current and low-current phases, wherein during a current cycle a plurality of high-current phases of different lengths and/or a plurality of low-current phases of different lengths are provided.

10. Method according to claim 9, wherein each cycle contains at least the following sequence: a high-current phase of 360 seconds, a low-current phase of 33 seconds, a high-current phase of 108 seconds, a low-current phase of 12 seconds,
particularly further followed by a high-current phase of 108 seconds, a low-current phase of 12 seconds, a high-current phase of 87 seconds, a low-current phase of 33 seconds, a high-current phase of 12 seconds and a low-current phase of 48 seconds.

11. Method according to claim 1, wherein the charging is stopped when a cell voltage reaches a value of 4.18 V.

12. Method according to claim 1, wherein the charging is latest initiated when a cell voltage falls to a value of 3.02 V.

13. Device for charging an arrangement of lithium-cobalt cells, wherein the device has a controller which is formed and structured to carry out the method of claim 1.
